(19) United States
(12) Patent Application Publication
(10) Pub. No.: US 2016/0041698 A1
(43) Pub. Date: Feb. 11, 2016

(54) Enhanced Object Organization in a Container

(71) Applicants: Vladimlr Tkach, Kafar Yona (IL); Valdim Tomnikov, Kfar Saba (IL)

(72) Inventors: Vladimlr Tkach, Kafar Yona (IL); Valdim Tomnikov, Kfar Saba (IL)

(21) Appl. No.: 14/452,289

(22) Filed: Aug. 5, 2014

(51) Int. Cl. G06F 3/0482; G06F 3/0481

(52) U.S. Cl. CPC G06F 3/0482; G06F 3/04817

(57) ABSTRACT

A device and method includes examining objects in a container to obtain metadata of the objects, deriving sorting rules from the obtained metadata, and sorting the objects in the container as a function of the meta data based on a list of attributes.

### BACKGROUND

A display of several objects may be arranged about a two-dimensional display space, referred to as a container. Changes to the position and size of the objects may be made based on rules existing within the container. The rules of the container are typically based on size, position, rating (frequency of use), as well as information from the objects inside the container. However, it is very difficult to extract such information for further manipulation by a user or other data processing system.

### SUMMARY

A method includes examining objects in a container to obtain metadata of the objects, deriving sorting rules from the obtained metadata, and sorting the objects in the container as a function of the meta data based on a list of attributes.

A machine readable storage device has instructions for execution by a processor of the machine to perform a method including examining objects in a container to obtain metadata of the objects, deriving sorting rules from the obtained metadata, and sorting the objects in the container as a function of the meta data based on a list of attributes.

A device includes a processor and a memory device coupled to the processor. A program is stored on the memory device for execution by the processor to examine objects in a container to obtain metadata of the objects, derive sorting rules from the obtained metadata, and sort the objects in the container as a function of the meta data based on a list of attributes.

### BRIEF DESCRIPTION OF THE DRAWINGS

FIG. 1 is an illustration of a container and object layout configuration manager according to an example embodiment.

FIG. 2 is a flowchart illustrating a method of organizing objects in a container according to an example embodiment.

FIG. 3 is a flowchart illustrating a method of organizing by removing empty spaces between objects in a container according to an example embodiment.

FIG. 4 is an illustration of a container and object layout configuration manager user interface for specifying layout rules according to an example embodiment.

FIG. 5 is an illustration of a container and object layout configuration manager user interface for specifying layout rules to minimize vertical spacing according to an example embodiment.

FIG. 6 is an illustration of a container and object layout configuration manager illustrating resulting object positions following application of the layout rules to minimize vertical spacing according to an example embodiment.

FIG. 7 is an illustration of a container and object layout configuration manager user interface for shoring a layout grid according to an example embodiment.

FIG. 8 is an illustration of a container and object layout configuration manager user interface for specifying layout rules to allow overlapping objects according to an example embodiment.

FIG. 9 is an illustration of a container and object layout configuration manager illustrating resulting object positions following application of the layout rules to allow overlapping objects according to an example embodiment.

FIG. 10 is an illustration of a container and object layout configuration manager user interface for specifying layout rules for drag-drop and resize actions according to an example embodiment.

FIG. 11 is an illustration of a container and object layout configuration manager user interface for specifying layout rules to tie the positions of two objects together according to an example embodiment.

FIG. 12 is an illustration of a container and object layout configuration manager user interface for specifying layout rules to cause two objects to be sized the same by changing the size of only one of the objects according to an example embodiment.

FIG. 13 is a block diagram of a computer system for implementing one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage device such as one or more memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

A method and system facilitate organizational layout of components in a container. In various embodiments, the term layout refers to organizing the appearance and placement of objects in the container. A workspace is a container that contains one or more pages. A page is a container that contains widgets, which are one type of object.

A widget in one embodiment is a stand-alone application that can be embedded into web pages. Generally, a widget occupies a portion of a web page and does something useful with information, such as displaying it. Other terms consistent with widget include portlet, web part, gadget, badge, module, snippet, and flake. Some example widgets include clocks, event countdowns, auction-tickers, stock market tickers, flight arrival information, weather information and others.

In one embodiment, widgets have associated meta-data which include one or more of static, dynamic, and content information. Static meta-data may be created by a user (administrator) and may add weight for widgets in order to allow layout functions to promote a widget with a highest weight to be positioned in a place that is most likely more attractive to the end-user (viewer/consumer), such as the upper left of a display screen showing the container.

Dynamic meta-data may generated by a system that tracks information about use of widgets. The dynamic meta-data may include a number of times a widget was clicked by all visitors of a page or site, referred to as usage analytics, may be used to allow layout functions to make a widget bigger or smaller as a function of the dynamic meta-data.

Content based meta-data may also be tracked by a system and may include the last content update time. One example involves widgets that present dynamic content such as a Twitter widget, RSS feed widget, TV shows tracker widget, etc. Content based meta-data may be used to allow layout functions to reorder widgets and place some of them with the latest content update time at the top of a page.

In further embodiments, organizing components in an abstract container may not only involve placing and sizing widgets inside a page (as in most of examples mentioned before). A TV/Radio stream may be treated as a container and movies/songs/advertisings may be treated as components. In this case, layout functions may define the order in which components will be added to the stream.

Static meta-data may include a duration of media (movie/song/ad), age restrictions, etc., in the stream. Dynamic meta-data may include a rate of the media in top charts, and content based meta-data may include things like profanity, enormous loud voice, and long pause detected in a speaker's speech. Layout functions may consider mixing in another sound (analog to widget overlapping), reduce volume (same as widget resizing), advertising may be broadcasted instead of a long pause (consider minimize spacing between widgets layout rule is enabled, widget is resized and some of the widgets pushed up because of redundant empty space to be removed.

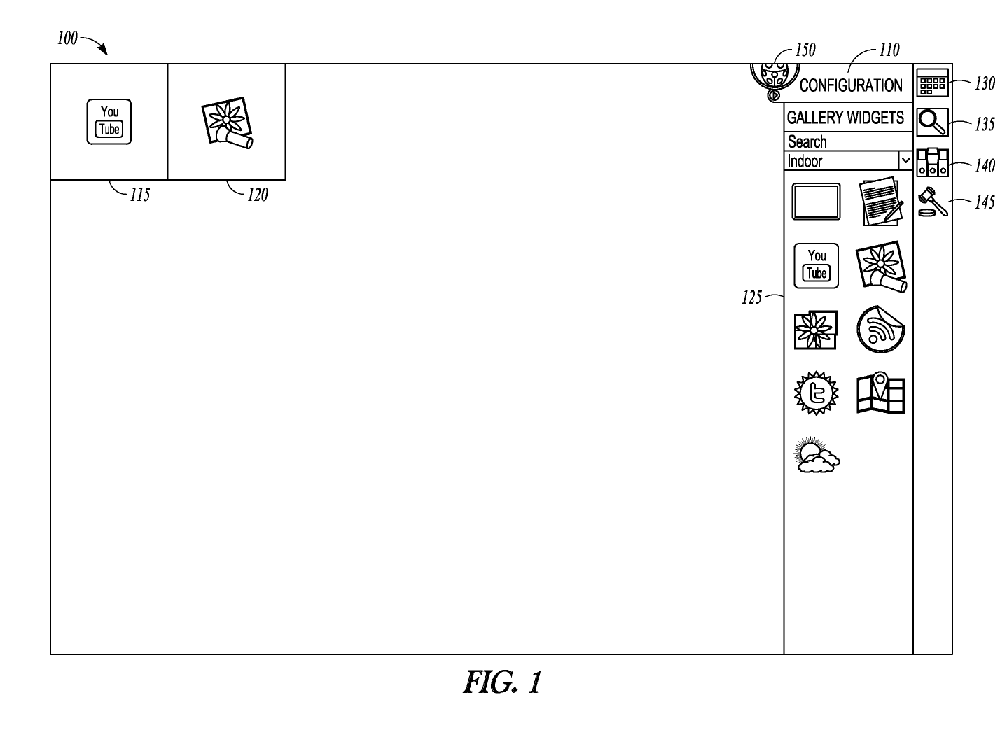

FIG. 1 is a snapshot of a container 100 including a configuration manager 110 to manage placement of objects within the container. In one embodiment, the objects comprise widgets. Two widgets, a video widget 115 and a drawing widget 120 are shown displayed in the container 100. The configuration manager provides a widget library 125 of multiple widgets to select from to add to the container. The widget library 125 may be opened via a library icon 130. A search icon 135 may be used to search for widgets, and page icon 140 may be used to select a page to be displayed. A rules icon 145 may be used to view rules associated with each widget. A grid icon 150 may be used to display a current set of rules for the container 100. The rules for the container 100 utilize the meta-data of the objects to determine how to place the objects within the container 100. Each container may have a different set of rules.

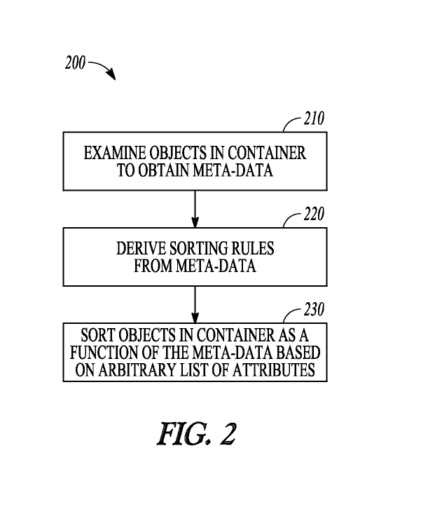

FIG. 2 is a flowchart illustrating a method 200 of laying out objects in a container. Method 200 includes at a high level, examining objects in a container to obtain metadata of the objects at 210. Sorting rules are derived from the obtained metadata at 220. Using the sorting rules, the objects at 230 are sorted in the container as a function of the-meta data based on an arbitrary list of attributes. In one embodiment, the rules are selected from the group consisting of size, position, and frequency of use of each object. Additional rules may be addable prior to sorting and a derived rule may be deleted prior to sorting. A derived rule may also be modified prior to sorting.

In one embodiment, the sorting rules comprise an arbitrary list of attributes. Some example rule attributes may include a size of each object, wherein each object is a widget displayed on a web page serving as the container. The rules may further comprise a position of the object within the container and may also include a frequency of use of each object. The rules may further include object overlap resolving rules, which may operate based on resolving rows, allowing overlapping of a specified object, and creating organizing rules dynamically based on a subset of meta-data exposed by another object.

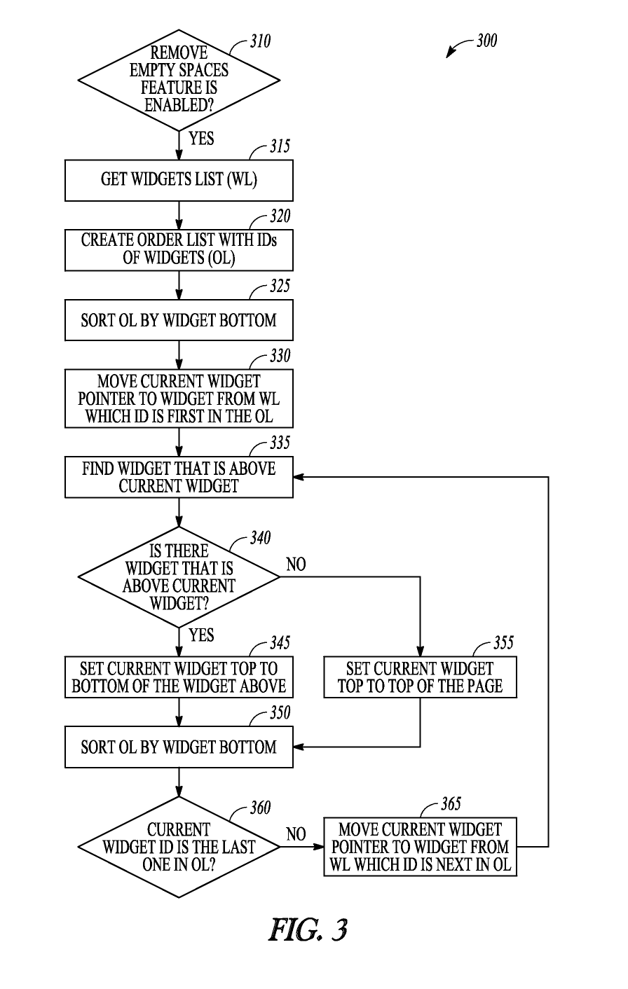

In a further more detailed method 300 illustrated in flowchart form in FIG. 3, a specific set of elements for implementation of a remove empty spaces feature is illustrated. At 310, the remove empty spaces feature is enabled. This may be done by a user in one embodiment using a configuration function and interface as shown in FIG. 1 and several following features which illustrate multiple different layout organization functions. At 315, a widgets list is obtained. Thousands of widgets may be stored in a library, but the widgets list is a list of widgets that are currently residing in the container for display on a page. An ordered list of IDs or widgets is created at 320. The IDs may be globally unique identifiers, or other types of identifiers of the widgets that are associated with each individual widget. At 325, the ordered list of widgets is sorted with reference to a bottom of the widget as appearing in the container.

At 330, a current widget pointer may be moved to a widget in the widget list which has an ID corresponding to the first widget in the ordered list. At 335, a widget that is above the current widget identified by the pointer is found. At a decision point 340, a determination is made if there is a widget that is above the current widget. If yes, at 345, the current widget top is set to appear at the bottom of the current widget. The ordered list is then sorted again by the widget bottom at 350. If at 340, there is no current widget that is above the current widget, the current widget is set to the top of the page/container at 355, and then the ordered list is sorted by widget bottom at 350.

Following sorting of the ordered list, a decision point at 360 is used to determine if the current widget ID is the last one in the ordered list. If not, the current widget point is moved to the widget ID which is next in the ordered list at 365. Method 300 then returns to find the widget that is above the current widget at 335. Method 300 will keep returning to 335 until the current widget ID is the last one in the ordered list at 360, whereupon the method ends until started again due to changes in the layout occur.

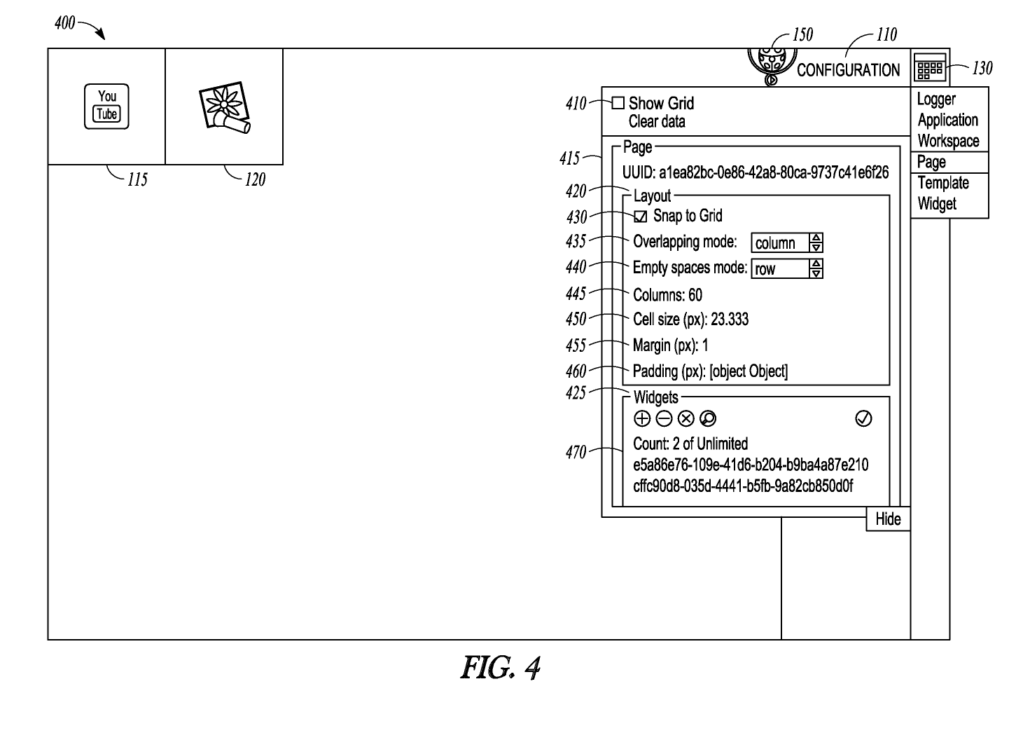

FIG. 4 is a view of a user interface 400 for viewing information about the container that may pop up when the grid icon 150 is selected, opening a runtime configuration tool allowing changing of layout organizing rules to for example, change the layout rules to minimize vertical spacing between widgets.

Interface 400 may contain a show grid checkbox 410, and information about the current container or page at 415, including a layout section 420 and a widgets section 425. Layout section 420 specifies some parameters for the current page with a UUID for the page, including a checkbox 430 to elect a snap to function for the grid, an overlapping mode 435 which may have options of none, row, and column, an empty spaces mode 440, the number of columns 445, cell size 450, margin 455, and padding for each widget or object at 460.

The widget section 425 may identify a count of the current number of widgets on the page and unique identifiers for such widgets. The widgets list 425 contains a count 470 of the number of widgets in the container and the IDs of the widgets.

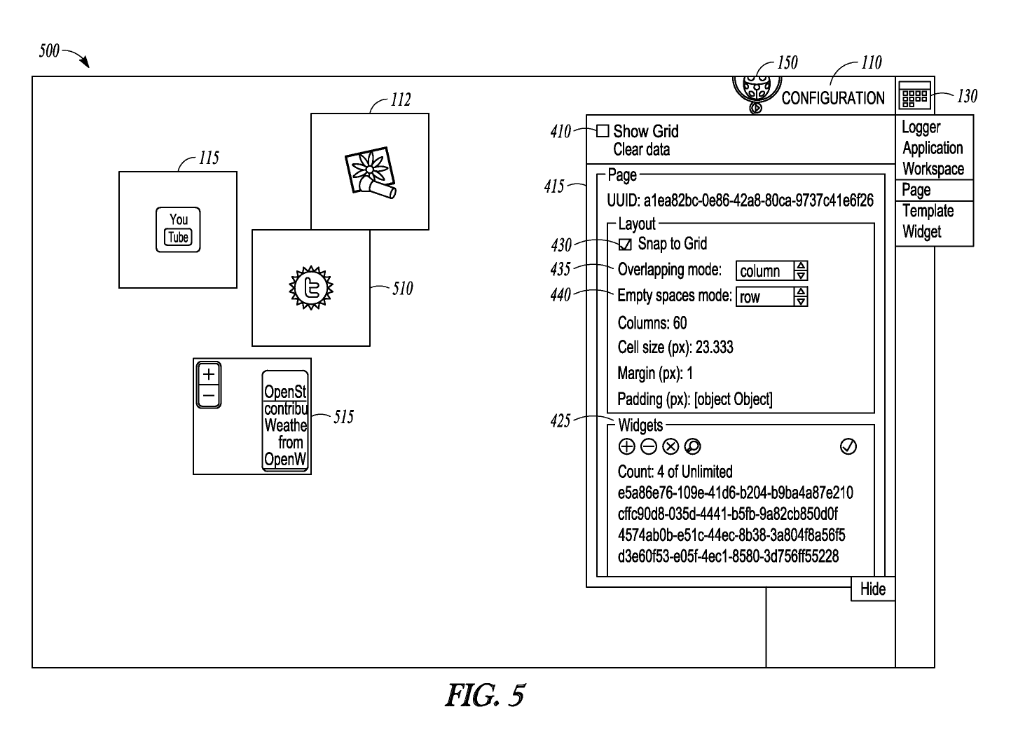

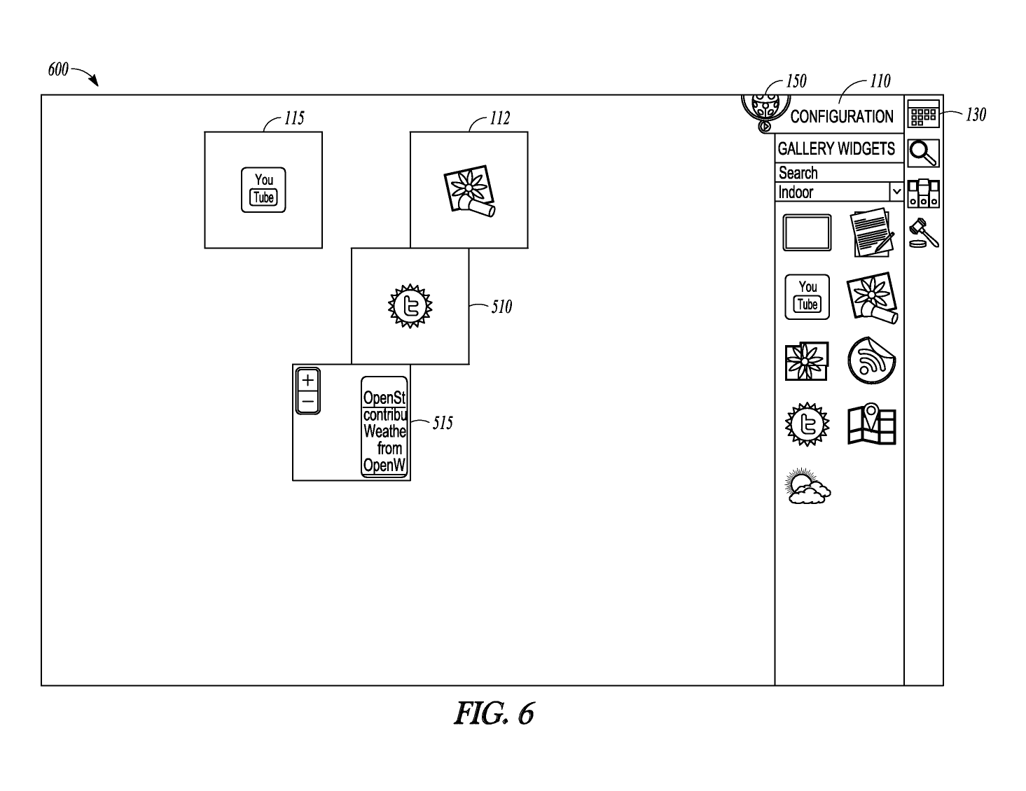

In one example shown in FIG. 5 at 500, widgets 115 and 120 have been moved, such as by a user. Two additional widgets 510 and 515 have been added. Widget 115 has been moved below the top of the container, and widget 515 is spaced below widget 510. The overlapping mode 435 has been set to column and the empty spaces mode 440 has been set to row. This results in minimizing vertical spacing between widgets as seen in FIG. 6 showing container 600. A change in the layout, such as moving one of the widgets, results in all the widgets moving such that there is no empty space in the container above any widget. As seen, widget 115 has been moved up to the top of the container 600, and widget 515 has its top moved adjacent to the bottom of widget 510. Note that if there had been no widget above widget 515, it would have moved to the top of the container 600.

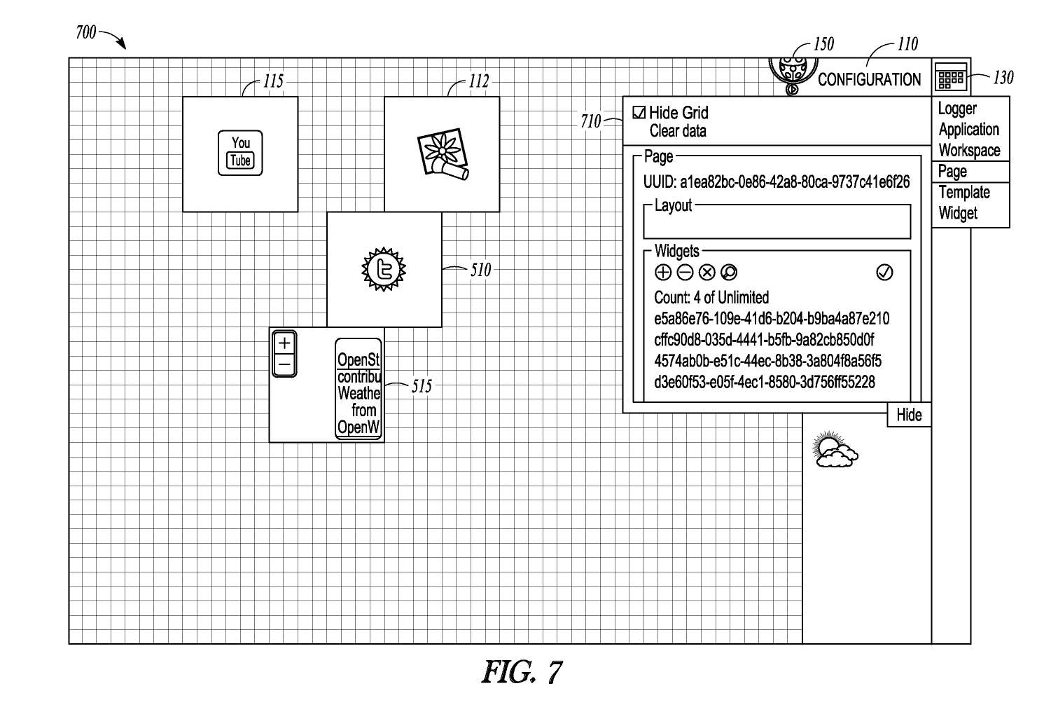

FIG. 7 illustrates a layout grid when the show grid checkbox 410 is checked. A grid 700 is shown over the container, and a hide grid checkbox 710 is displayed in place of the show grid checkbox 410. Checking the hide grid checkbox and executing the function associated with it, removes the grid 700.

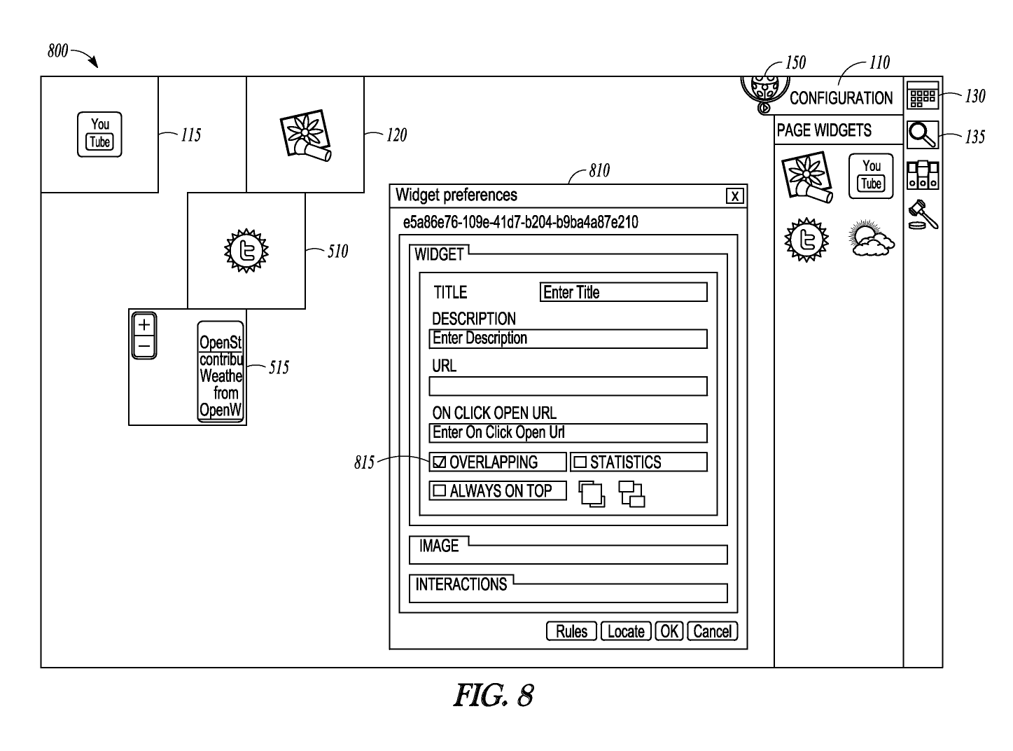

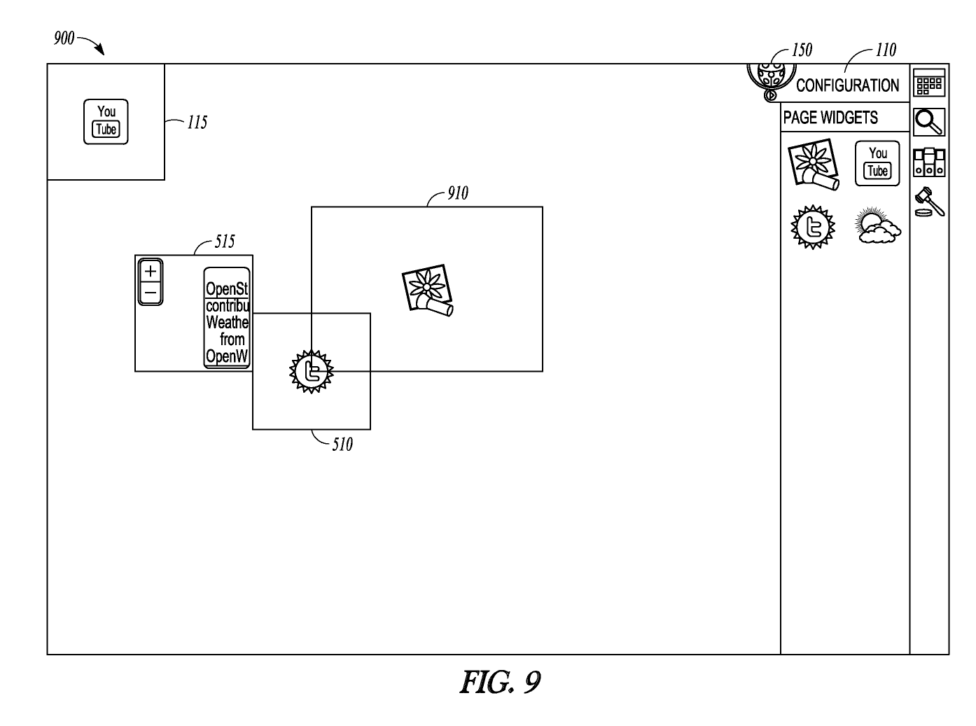

FIG. 8 illustrates a container 800 to illustrate changing widget meta-data to define a layout organizing rule that allows a widget to be overlapped. A user may first click the search icon 135, then select a widget. A widget preferences window 810 then appears providing tabs corresponding to widget information, image, and interactions. Many different options may be provided such as adopt. dimensions, after.create.item, after.destroy.items, after.init.config, after.resize.window, before.init.config, clear.thumbnail, create.draggable, disable.draggable, disable.resizable, drag.draggable, enable.draggable, enable resizable, init.draggable, init.resizable, load.content, resize.resizable, save.dom, set. always.on.down, set.layer.down, set.layer.up, set.on.click.url, start.draggable, start resizable, stop.draggable, stop.resizable and others. In the window 810 shown, an overlapping checkbox 815 has been checked, allowing the particular widget to be overlapped with another widget as shown in FIG. 9. Note that in FIG. 9, the widget 910 (an enlarged version of widget 120) that was provided overlapping ability may be overlapped with any of the other widgets, but the other widgets do not overlap with each other. When the other widgets are so moved, they follow the other rules and are moved to comply with such rules. Widget 910 was also resized from widget 120. Note also, that a further rule was changed for widget 910 to overlap other widgets. The empty spaces mode 440 was changed from column, to none. Otherwise, widget 910 would still have obeyed the empty spaces rule by moving the widget to remove spaces in columns of widgets.

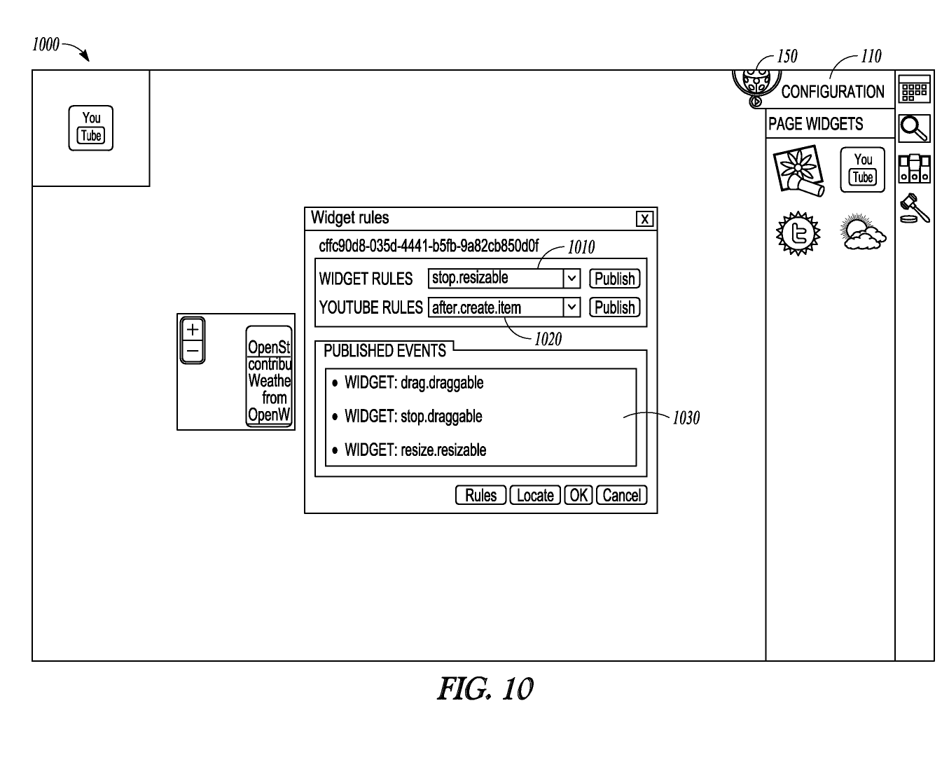

In FIG. 10 at 1000, the widget configuration manager 110 facilitates using a widget's meta-data that is relevant to drag-drop and resize actions. At 1010, “stop.resizeable” is shown as selected from a drop down menu, and at 1020, an “after.create.item” rule is shown selected for a particular widget, YouTube®. Prior published events are also shown at 1030 including drag.draggable, stop.draggable, and resize.resizable.

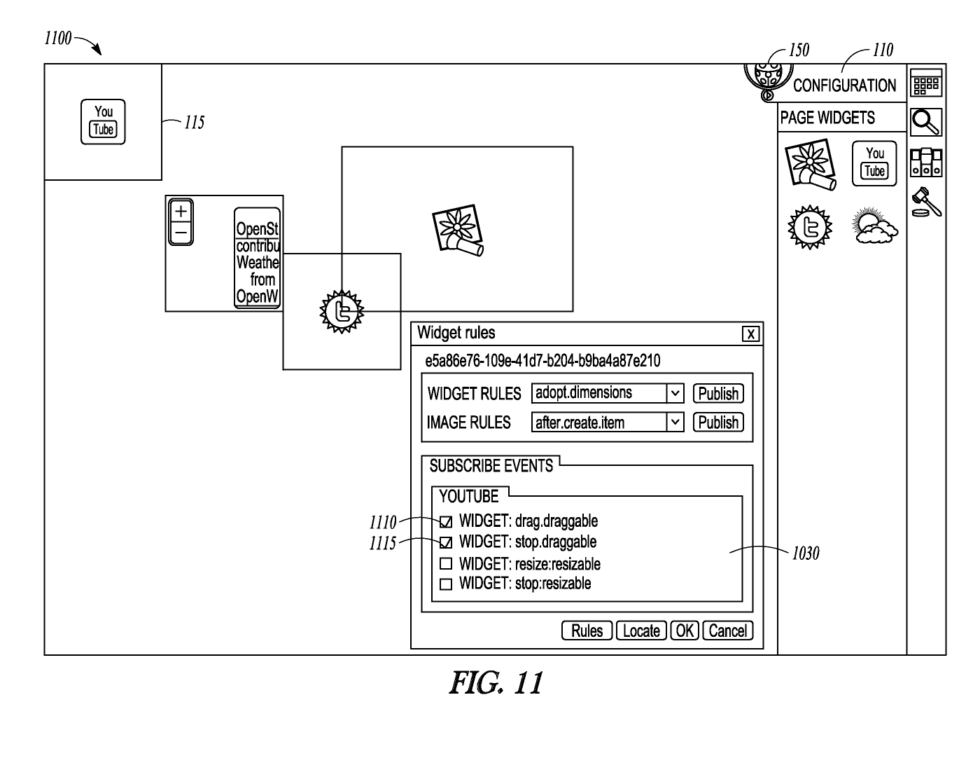

In FIG. 11 at 1100, the configuration manager 110 for one widget has been used to create a layout organizing rule that allows use of meta-data regarding widget position exposed by a first widget to affect the position of a second widget. The effect of such an organizing rule ties the positions of two widgets together, such that moving one of the widgets causes both widgets to move in the same manner, maintaining their spaced relationship. In this example, widget 115 has subscribe events of drag.draggable 1110 and stop.draggalbe 1115 checked.

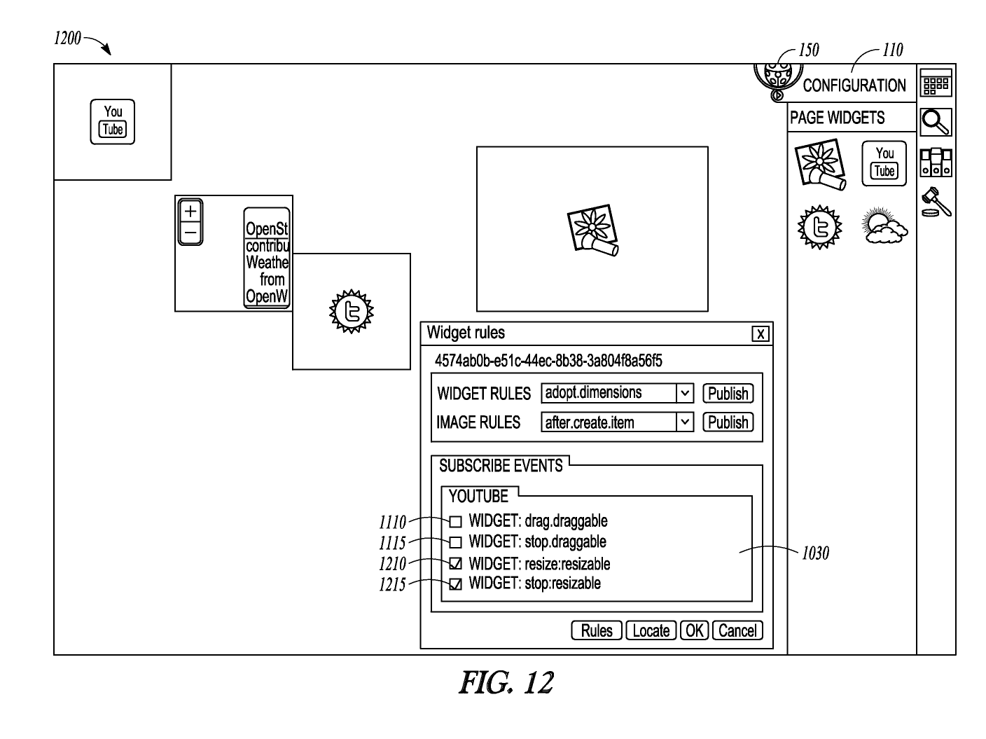

FIG. 12 at 1200 shows the selection of resize.resizable 1210 and stop.resizable 1215 checkboxes to cause two widgets to be sized the same by changing the size of only one of the widgets. The configuration tool of a third widget allows creation of a layout organizing rule that allows the use of meta-data regarding widget size exposed by a first widget to affect the size of the third widget. By checking all four of the checkboxes in the configuration tool interface of the third widget allows the use of meta-data regarding widget position exposed by the first widget to affect position as well as size of the third widget.

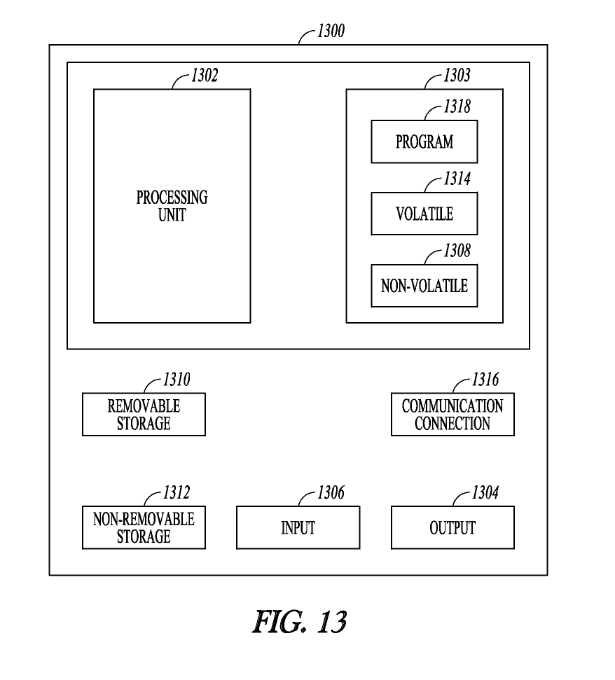

FIG. 13 is a block schematic diagram of a computer system 1300 to implement the layout organization functions according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 1300, may include a processing unit 1302, memory 1303, removable storage 1310, and non-removable storage 1312. Memory 1303 may include volatile memory 1314 and non-volatile memory 1308. Computer 1300 may include—or have access to a computing environment that includes—a variety of computer-readable media, such as volatile memory 1314 and non-volatile memory 1308, removable storage 1310 and non-removable storage 1312. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1300 may include or have access to a computing environment that includes input 1306, output 1304, and a communication connection 1316. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1302 of the computer 1300. A hard drive, CD-ROM, and RAM are some examples of articles including a non-transitory computer-readable medium. For example, a computer program 1318 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1300 to provide generic access controls in a COM based computer network system having multiple users and servers.

### EXAMPLES

1. A method comprising:

examining objects in a container to obtain metadata of the objects;

deriving sorting rules from the obtained metadata; and

sorting the objects in the container as a function of the meta data based on a list of attributes.

2. The method of example 1 wherein the rules are selected from the group consisting of size, position, and frequency of use of each object.

3. The method of any of examples 1-2 wherein the metadata from which the rules are generated includes at least static, dynamic, or content information.

4. The method of any of examples 1-3 wherein a derived rule is deletable prior to sorting.

5. The method of any of examples 1-4 wherein a derived rule is modifiable prior to sorting.

6. The method of any of examples 1-5 wherein the sorting rules comprise an arbitrary list of attributes.

7. The method of any of examples 1-6 wherein the rules comprise a size of each object, wherein each object is a widget displayed on a web page serving as the container.

8. The method of any of examples 1-7 wherein the rules comprise a position of the object within the container.

9. The method of any of examples 1-8 wherein the rules comprise a frequency of use of each object.

10. The method of any of examples 1-9 wherein the rules comprise object overlap resolving rules.

11. The method of any of examples 1-10 wherein the rules comprise row resolving rules.

12. The method of any of examples 1-11 wherein the rules comprise a rule to allow overlapping of a specified object.

13. The method of any of examples 1-13 wherein the rules for an object comprise layout organizing rules dynamically created based on a subset of meta-data exposed by another object.

14. A machine readable storage device having instructions for execution by a processor of the machine to perform:

examining objects in a container to obtain metadata of the objects;

deriving sorting rules from the obtained metadata; and

sorting the objects in the container as a function of the meta data based on a list of attributes.

15. The machine readable storage device of example 14 wherein the rules are selected from the group consisting of size, position, and frequency of use of each object.

16. The machine readable storage device of any of examples 14-15 wherein the metadata from which the rules are generated includes at least static, dynamic, or content information.

17. The machine readable storage device of any of examples 14-16 wherein the rules comprise a rule to allow overlapping of a specified object.

18. The machine readable storage device of any of examples 14-17 wherein the rules for an object comprise layout organizing rules dynamically created based on a subset of meta-data exposed by another object.

19. A device comprising:

a processor;

a sensor supported by the device; and

a memory device coupled to the processor and having a program stored thereon for execution by the processor to:

examine objects in a container to obtain metadata of the objects;

derive sorting rules from the obtained metadata; and

sort the objects in the container as a function of the meta data based on a list of attributes.

20. The device of example 19 wherein the rules for an object comprise layout organizing rules dynamically created based on a subset of meta-data exposed by another object.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
examining objects in a container to obtain metadata of the objects;
deriving sorting rules from the obtained metadata; and
sorting the objects in the container as a function of the meta data based on a list of attributes.

2. The method of claim 1 wherein the rules are selected from the group consisting of size, position, and frequency of use of each object.

3. The method of claim 1 wherein the metadata from which the rules are generated includes at least static, dynamic, or content information.

4. The method of claim 1 wherein a derived rule is deletable prior to sorting.

5. The method of claim 1 wherein a derived rule is modifiable prior to sorting.

6. The method of claim 1 wherein the sorting rules comprise an arbitrary list of attributes.

7. The method of claim 1 wherein the rules comprise a size of each object, wherein each object is a widget displayed on a web page serving as the container.

8. The method of claim 1 wherein the rules comprise a position of the object within the container.

9. The method of claim 1 wherein the rules comprise a frequency of use of each object. 10. The method of claim 1 wherein the rules comprise object overlap resolving rules.

11. The method of claim 1 wherein the rules comprise row resolving rules.

12. The method of claim 1 wherein the rules comprise a rule to allow overlapping of a specified object.

13. The method of claim 1 wherein the rules for an object comprise layout organizing rules dynamically created based on a subset of meta-data exposed by another object.

14. A machine readable storage device having instructions for execution by a processor of the machine to perform:
examining objects in a container to obtain metadata of the objects;
deriving sorting rules from the obtained metadata; and
sorting the objects in the container as a function of the meta data based on a list of attributes.

15. The machine readable storage device of claim 14 wherein the rules are selected from the group consisting of size, position, and frequency of use of each object.

16. The machine readable storage device of claim 14 wherein the metadata from which the rules are generated includes at least static, dynamic, or content information.

17. The machine readable storage device of claim 14 wherein the rules comprise a rule to allow overlapping of a specified object.

18. The machine readable storage device of claim 14 wherein the rules for an object comprise layout organizing rules dynamically created based on a subset of meta-data exposed by another object.

19. A device comprising:
a processor;
a sensor supported by the device; and
a memory device coupled to the processor and having a program stored thereon for execution by the processor to:
examine objects in a container to obtain metadata of the objects;
derive sorting rules from the obtained metadata; and
sort the objects in the container as a function of the meta data based on a list of attributes.

20. The device of claim 19 wherein the rules for an object comprise layout organizing rules dynamically created based on a subset of meta-data exposed by another object.
